(19) United States
(12) Patent Application Publication
(10) Pub. No.: US 2010/0257571 A1
(43) Pub. Date: Oct. 7, 2010

(54) INFORMATION DELIVERY SYSTEM AND METHOD, INFORMATION DELIVERY DEVICE, AND RECEPTION DEVICE

(75) Inventors: Shinya Hashimoto, Saitama (JP); Yasuyuki Noda, Saitama (JP); Yukio Numakami, Saitama (JP); Tetsuya Kawahara, Saitama (JP); Ken Miyagawa, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/668,848

(22) PCT Filed: Jul. 13, 2007
(86) PCT No.: PCT/JP2007/063988

§ 371 Date: May 25, 2010

(51) Int. Cl. H04N 7/173

(52) U.S. Cl. 725/116

(57) ABSTRACT

An information delivery system in which in a display device (2) for displaying a first content and a second content, it is detected whether or not the displayed first content is changed to other content that is different from the first content and when the change is the predetermined change that is set in advance, the second content is delivered from an information delivery device (1) that receives a delivery request to the display device and displayed. Therefore, the desired second content is provided without interrupting a user's viewing of the first content.

### TECHNICAL FIELD

The present invention relates to an information delivery system, apparatus, and method for displaying second content delivered through a network on a first content display apparatus on a user side.

### BACKGROUND ART

As this type of information delivery system, for example, a patent document 1 discloses a technology of displaying information delivered through a predetermined network from a server side in an information providing system which displays program content. The patent document 1 further discloses a technology of detecting a user's response to the delivered information and of determining new delivery and display timing in accordance with the situation of the response. In this technology, the user's response to the delivered information is detected, and a history of the response is accumulated, and the timing of new delivery is determined on the basis of at least one of response frequency and a response time between the delivery and the user's response.

### Patent Document 1: Japanese Patent Application Laid Open No. 2004-199667

### DISCLOSURE OF INVENTION

### Subject to be Solved by the Invention

According to the aforementioned background art, proper timing of new delivery is determined in response to feedback based on the user's response; however, there is no feedback information in the first delivery, and the user's program content watching is likely prevented in the delivery. Moreover, under the circumstances that the history of the user's operation is not fully accumulated, the proper timing which prevents the user's program content watching cannot be determined, and a similar situation may arise, which is technically problematic.

In view of the aforementioned problem, it is therefore an object of the present invention to provide an information delivery system, apparatus, and method used therein in which information is displayed in proper timing which does not prevent the user's content watching.

### Means for Solving the Subject

The above object of the present invention can be achieved by an information delivery system provided with: a display apparatus provided with a displaying device for displaying first content; and an information delivery apparatus provided with a delivering device for delivering second content to the display apparatus through a predetermined network, at least one of the display apparatus and the information delivery apparatus provided with a judging device for judging whether or not the first content displayed by the displaying device is changed to content different from the first content, the display apparatus provided with a controlling device for controlling the displaying device to display the second content delivered from the information delivery apparatus if it is judged that the first content displayed by the displaying device is changed to the content different from the first content.

The above object of the present invention can be also achieved by an information delivery apparatus provided with: a delivering device for delivering second content to a display apparatus provided with a displaying device for displaying first content, through a network; a judging device for judging whether or not the first content displayed on the display apparatus is changed to content different from the first content; and a transmitting device for transmitting display start information for starting the display of the second content on the display apparatus, to the display apparatus if it is judged that the first content displayed by the displaying device is changed to the content different from the first content.

The above object of the present invention can be also achieved by a receiving apparatus provided with: a displaying device for displaying first content; a judging device for judging whether or not the displayed first content is changed to content different from the first content; and a controlling device for controlling the displaying device to display the second content delivered from the information delivery apparatus if it is judged that the first content displayed by the displaying device is changed to the content different from the first content.

The above object of the present invention can be also achieved by an information delivery method in an information delivery system provided with: a display apparatus provided with a displaying device for displaying first content; and an information delivery apparatus provided with a delivering device for delivering second content to the display apparatus through a predetermined network, the information delivery method provided with: a judging process of judging whether or not the first content displayed by the displaying device is changed to content different from the first content; and a controlling process of controlling the displaying device to display the second content delivered from the information delivery apparatus if it is judged that the first content displayed by the displaying device is changed to the content different from the first content.

The operation and other advantages of the present invention will become more apparent from the embodiments explained below.

### BRIEF DESCRIPTION OF DRAWINGS

FIG. 1 is a schematic block diagram showing an information delivery system in a first example of the present invention.

FIG. 2 is a flowchart showing a flow of operations of the information delivery system in the first example of the present invention.

FIG. 3 is view showing one example of a list of second content in the first example of the present invention.

FIG. 4 is an image showing a display apparatus for displaying first content and second content in the first example of the present invention.

FIG. 5 is a flowchart showing a flow of operations of an information delivery system in a first modified example of the present invention.

FIG. 6 is a schematic block diagram showing an information delivery system in a second modified example of the present invention.

FIG. 7 is a flowchart showing a flow of operations of the information delivery system in the second modified example of the present invention.

FIG. 8 is a flowchart showing a flow of operations of an information delivery system in a third modified example of the present invention.

FIG. 9 is a flowchart showing a flow of operations of an information delivery system in a fourth modified example of the present invention.

FIG. 10 is a schematic block diagram showing an information delivery system in a second example of the present invention.

FIG. 11 is a flowchart showing a flow of operations of the information delivery system in the second example of the present invention.

FIG. 12 is a flowchart showing a flow of operations of an information delivery system in a fifth modified example of the present invention.

FIG. 13 is a schematic block diagram showing an information delivery system in a sixth modified example of the present invention.

FIG. 14 is a flowchart showing a flow of operations of the information delivery system in the sixth modified example of the present invention.

FIG. 15 is a schematic block diagram showing an information delivery system in a third example of the present invention.

FIG. 16 is a flowchart showing a flow of operations of the information delivery system in the third example of the present invention.

FIG. 17 is a flowchart showing a flow of operations of an information delivery system in a seventh modified example of the present invention.

FIG. 18 is a schematic block diagram showing an information delivery system in an eighth modified example of the present invention.

FIG. 19 is a flowchart showing a flow of operations of the information delivery system in the eighth modified example of the present invention.

### DESCRIPTION OF REFERENCE CODES

1 information delivery apparatus
2 display apparatus
101 (information delivery apparatus) control device
102 (information delivery apparatus) information obtaining device
103 (information delivery apparatus) delivery control device
104 (information delivery apparatus) communication device
105 (information delivery apparatus) operation analysis device
106 (information delivery apparatus) feature quantity analysis device
107 (information delivery apparatus) first content obtaining device
108 (information delivery apparatus) associated information obtaining/analysis device
201 (display) control device
202 (display) first content input device
203 (display) display device
204 (display) communication device
205 (display) operation reception device
206 (display) operation analysis device
207 (display) feature quantity analysis device
208 (display) associated information obtaining/analysis device

### BEST MODE FOR CARRYING OUT THE INVENTION

An embodiment of the information delivery system of the present invention is an information delivery system provided with: a display apparatus provided with a displaying device for displaying first content; and an information delivery apparatus provided with a delivering device for delivering second content to the display apparatus through a predetermined network, at least one of the display apparatus and the information delivery apparatus provided with a judging device for judging whether or not the first content displayed by the displaying device is changed to content different from the first content, the display apparatus provided with a controlling device for controlling the displaying device to display the second content delivered from the information delivery apparatus if it is judged that the first content displayed by the displaying device is changed to the content different from the first content.

According to the embodiment of the information delivery system of the present invention, if the displayed first content is changed to the content different from the first content when the user watches the first content displayed on the display apparatus, the change is detected by the operation of the judging device, and the second content delivered by the information delivery apparatus is displayed on the display apparatus by the operation of the controlling device. Here, the “first content” is content (e.g. video content) such as terrestrial, CS, BS broadcast content or the like, data delivered through the network, and output from a recording/reproducing apparatus connected to the display apparatus. The “display apparatus” is an apparatus which can display at least the aforementioned video content and which has a function capable of changing the display of a plurality of contents. The expression that the “first content is changed to the content different from the first content” means a predetermined change is made in the displayed content, such as a change in the content of the displayed content and a change between a main body and CM (Commercial Message). Moreover, the “second content” is information valuable to the user, such as prompt report news and advertisement.

As described above, according to the information delivery system in the embodiment, the second content is displayed in the timing that the displayed first content is changed to the content different from the first content. The predetermined change made in the displayed content is ending or interrupting the watching of the first content which has been watched. The user's interest in the first content after the change is also supposedly lower than before the change. By displaying news, advertisement, or the like as the second content in this timing, it is possible to display the second content without preventing the user's first content watching.

In one aspect of the embodiment, the first content is a broadcast program broadcasted in accordance with a program determined in advance, and the first content is different from the second content delivered through the network from the information delivery apparatus.

According to this aspect, the first content and the second content have different information, and they are different contents displayed on the display apparatus by different devices. In particular, the first content is the broadcast content delivered through the broadcasting. Thus, when the information delivery apparatus delivers the second content, it can deliver the second content which is different from the first content displayed on the display apparatus.

In one aspect of the embodiment, at least one of the display apparatus and the information delivery apparatus is further provided with an extracting device for extracting feature quantity information indicating features of the first content displayed by the displaying device, the judging device judges whether or not there is a poor correlation in the first content between before and after the change when the first content displayed by the displaying device is changed to the content different from the first content, on the basis of the feature quality information, and the controlling device controls the displaying device to display the second content delivered from the information delivery apparatus if it is judged that there is the poor correlation in the first content between before and after the change when the first content displayed by the displaying device is changed to the content different from the first content.

According to this aspect, the judging device detects the change in the displayed first content by analyzing the feature quality of the content extracted by the extracting device which is provided for at least one of the display apparatus and the information delivery apparatus. The judging device judges whether or not there is the poor correlation in the feature quality between before and after the detected change in the first content. The judging device transmits a request for the delivery of the second content if it is judged that there is the poor correlation, i.e. if it is judged that the predetermined change is made. As a result, the delivering device provided for the information delivery apparatus delivers the second content in response to the delivery request. Thus, the second content can be delivered and displayed in response to the predetermined change which supposedly reduces the user's interest in the change in the displayed first content.

In another aspect of the embodiment, the judging device is provided for the display apparatus, the display apparatus is further provided with a requesting device for requesting the information delivery apparatus to deliver the second content if it is judged that the first content displayed by the displaying device is changed to the content different from the first content, and the delivering device delivers the second content after the request by the requesting device.

According to this aspect, when the change in the displayed first content is judged by the judging device provided for the display apparatus and the change in the first content is the predetermined change which reduces the user's interest in the first content between before and after the change, the requesting device provided for the display apparatus requests the information delivery apparatus to deliver the second content. As a result, the delivering device provided for the information delivery apparatus delivers the second content in response to the delivery request. Thus, the second content can be delivered and displayed in response to the predetermined change in the first content without a special structure for accumulating the delivered information and for performing the display in response to the user's operation, on the display apparatus.

In another aspect of the embodiment, the judging device is provided for the display apparatus, the delivering device delivers the second content in advance, and the controlling device controls the displaying device to display the second content delivered in advance if it is judged that the displayed first content is changed to the content different from the first content.

According to this aspect, the display apparatus can display the second content delivered in advance without waiting for the delivery from the information delivery apparatus, in response to the change in the displayed first content. Thus, the second content can be displayed without consideration of time loss which supposedly occurs due to the delivery through the network.

In another aspect of the embodiment, the judging device is provided for the information delivery apparatus, and the delivering device delivers the second content if it is judged that the first content displayed by the displaying device is changed to the content different from the first content.

According to this aspect, by the information delivery apparatus side judging the change, it is possible to deliver the second content without a special structure for judging the change within the display apparatus. Moreover, one information delivery apparatus may allow a plurality of display apparatuses owned by individual users to perform the processes. At that time, a working process, such as the analysis of the change, and the judgment of the predetermined change, is easily managed, and when the working process is revised, it is possible to relatively easily respond to the revision.

Alternatively, in an aspect in which the judging device is provided for the information delivery apparatus, the judging device is provided for the information delivery apparatus, the information delivery apparatus is further provided with an information obtaining device for obtaining the same first content as the first content displayed on the display apparatus, and the delivering device delivers the second content if it is judged that the first content obtained by the information obtaining device is changed to the content different from the first content

By virtue of such construction, it is possible to deliver the second content by specifying the first content currently displayed on the display apparatus from the user's operation or the like and by the information delivery apparatus obtaining the same content to perform the process of judging the change in the first content on the information delivery apparatus side without a special structure for judging the operation within the display apparatus.

In another aspect of the embodiment, the controlling device controls the displaying device to display the second content the first content.

According to this aspect, by limiting an area to display the second content, the user can watch the second content while watching the first content. Therefore, it is possible to reduce an influence of preventing the user from watching first content. Moreover, this effect becomes more evident by making the displayed second content transmissive or transparent to the extent that does not prevent the watching, or by displaying the second content not by occupying all of the first content but by using a part of it.

In another aspect of the embodiment, the information delivery apparatus is further provided with: an obtaining device for obtaining the second content from external recording equipment or the network; and a delivery controlling device for storing the obtained second content and listing the second content to be delivered to the display apparatus.

According to this aspect, the information delivery apparatus can newly obtain the second content to be delivered, and it can list the second content and control the delivery if there are many obtained second contents. Moreover, in the listing, it is also possible to set the second content to be listed and the listing priority in order to deliver the second content in response to the user's preference.

An embodiment of the information delivery apparatus of the present invention is an information delivery apparatus provided with: a delivering device for delivering second content to a display apparatus provided with a displaying device for displaying first content, through a network; a judging device for judging whether or not the first content displayed on the display apparatus is changed to content different from the first content; and a transmitting device for transmitting display start information for starting the display of the second content on the display apparatus, to the display apparatus if it is judged that the first content displayed by the displaying device is changed to the content different from the first content.

According to the embodiment of the information delivery apparatus of the present invention, it is possible to display the second content on the display apparatus in timing in which the predetermined change is made in the first content in which the user who watches the first content has supposedly lost the interest in the first content watching. Thus, it is possible to display the second content valuable to the user without preventing the user's first content watching.

Incidentally, even the embodiment of the information delivery apparatus of the present invention can adopt the same various aspects as those of the information delivery apparatus in the embodiment of the information delivery system of the present invention described above.

An embodiment of the receiving apparatus of the present invention is a receiving apparatus provided with: a displaying device for displaying first content; a judging device for judging whether or not the displayed first content is changed to content different from the first content; and a controlling device for controlling the displaying device to display the second content delivered from the information delivery apparatus if it is judged that the first content displayed by the displaying device is changed to the content different from the first content.

According to the embodiment of the display apparatus of the present invention, it is possible to display the second content delivered from the information delivery apparatus in timing in which the predetermined change is made in the first content in which the user who watches the first content has supposedly lost the interest in the first content watching. Thus, it is possible to display the second content valuable to the user without preventing the user's first content watching.

Incidentally, even the embodiment of the display apparatus of the present invention can adopt the same various aspects as those of the display apparatus in the embodiment of the information delivery system of the present invention described above.

An embodiment of the information delivery method of the present invention is an information delivery method in an information delivery system provided with: a display apparatus provided with a displaying device for displaying first content; and an information delivery apparatus provided with a delivering device for delivering second content to the display apparatus through a predetermined network, the information delivery method provided with: a judging process of judging whether or not the first content displayed by the displaying device is changed to content different from the first content; and a controlling process of controlling the displaying device to display the second content delivered from the information delivery apparatus if it is judged that the first content displayed by the displaying device is changed to the content different from the first content.

According to the embodiment of the information delivery method of the present invention, as in the case of the information delivery system of the present invention described above, it is possible to deliver and display the second content on the display apparatus in timing in which the predetermined change is made in the first content in which the user who watches the first content has supposedly lost the interest in the first content watching. Thus, it is possible to display the second content valuable to the user without preventing the user's first content watching.

Incidentally, even the embodiment of the information delivery method of the present invention can adopt the same various aspects as those in the embodiment of the information delivery system of the present invention described above.

The operation and other advantages of the embodiments will become more apparent from examples explained below.

As explained above, according to the embodiment of the information delivery system of the present invention, it is provided with the display apparatus provided with the displaying device; and the information delivery apparatus provided with the delivering device, wherein at least one of the display apparatus and the information delivery apparatus is provided with the judging device, and the display apparatus is provided with the controlling device. The embodiment of the information delivery apparatus of the present invention is provided with the delivering device, the judging device, and the transmitting device. The embodiment of the display apparatus of the present invention is provided with the displaying device, the judging device, and the controlling device. The embodiment of the information delivery method of the present invention is provided with the judging process and the controlling process. Therefore, it is possible to display the second content in proper timing which does not prevent the user's first content watching.

### EXAMPLES

### First Example

A first example of the information delivery system of the present invention will be explained with reference to the drawings. Incidentally, the same constituent elements in the drawings will carry the same referential numerals.

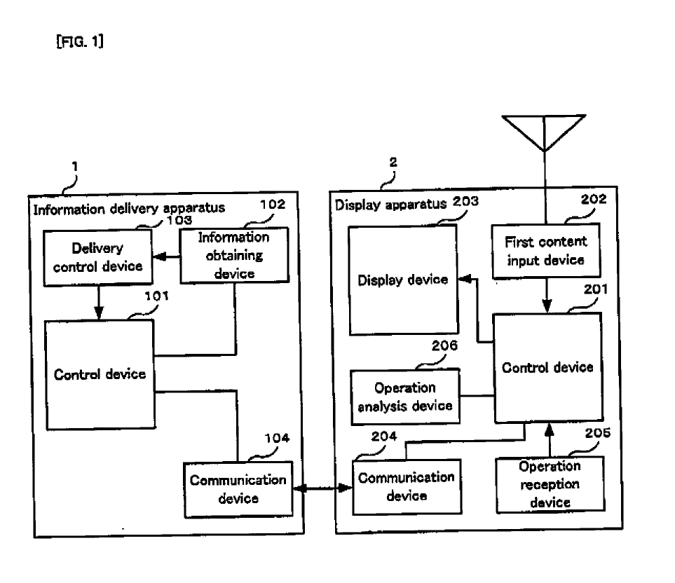

Firstly, the structure of the information delivery system in the first example will be explained with reference to FIG. 1. FIG. 1 is a block diagram showing the information delivery system provided with a display apparatus 2 for displaying first content and an information delivery apparatus 1 for delivering second content to the display apparatus 2 through a predetermined network.

The information delivery apparatus 1 is provided with an information obtaining device 102 for obtaining the delivered second content; a delivery control device 103 for listing and accumulating the obtained second content; a control device 101 for controlling the operations of the information delivery apparatus 1, such as receiving a delivery request from the display apparatus 2, sending the second content listed by the delivery control device 103 to a communication device 104, and storing the second content obtained by the information obtaining device 102 into the delivery control device 103; and the communication device 104 for receiving information such as the delivery request.

The display apparatus 2 is provided with a display device 203 for displaying the first content and the second content; a first content input device 202 for inputting the first content; an operation reception device 205 for receiving a user's operation and sending it to a control device 201; an operation analysis device 206 for analyzing the user's operation sent through the control device 201 and sending the result to the control device 201; the control device 201 for controlling the operations of the display apparatus 2, such as making the display device 203 display the inputted first content and the received second content, sending the user's operation received by the operation reception device 205 to the operation analysis device 206, and sending a delivery request to the communication device 204 in accordance with the user's operation control analyzed by the operation analysis device 206; and a communication device 204 for transmitting information, such as the delivery request, to the information delivery apparatus 1 connected through the network and for receiving the second content.

The information delivery system as constructed above, as detailed later, detects the user's operation when a user changes the displayed first content while watching the first content displayed on the display apparatus 2, and it makes the display apparatus 2 display the second content delivered by the information delivery apparatus 1.

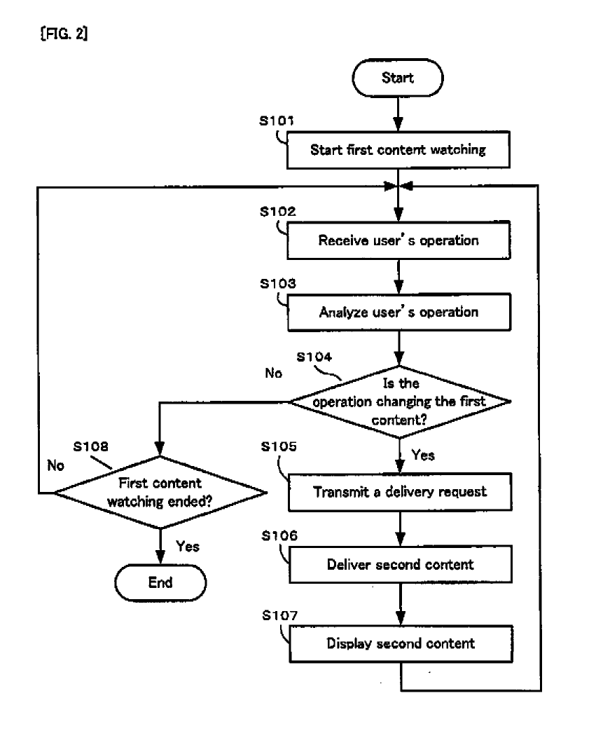

Next, the details of the operations of the information delivery system as constructed above will be explained with reference to a flowchart in FIG. 2.

In FIG. 2, firstly, the first content input device 202 receives the input of the first content, and the control device 201 makes the display device 203 display the first content, which allows the user to start the first content watching (step S101).

When the user operates the display apparatus 2 through operation equipment such as a remote controller, the operation reception device 205 detects the user's operation and transmits the operation content to the control device 201 (step S102). The control device 201 inputs the user's operation to the operation analysis device 206, and the user's operation is analyzed on the operation analysis device (step S103).

Here, if the user's operation is changing the first content (step S104: Yes), the result is sent to the control device 201, and the control device 201 sends a delivery request to the communication device 204, and the communication device 204 transmits the delivery request to the information delivery apparatus 1 through the network (step S105).

Here, the first content changing operation means an operation when the displayed content is changed by the user's operation, for example, such as an operation of changing the channel of the first content displayed on the display device 203 (e.g. an operation of changing from 1CH to 4CH), an operation of changing the source of the first content (e.g. an operation of changing from terrestrial digital broadcast to BS digital broadcast), an operation of changing from the display of video content to the display of text content (in other words, data broadcast), and an operation of changing from fee-based content to free content.

On the information delivery apparatus 1 which has received the delivery request, the delivery request is sent from the communication device 104 to the control device 101, and the second content obtained on the information obtaining device 102 is sent to the delivery control device 103. The delivery control device 103 lists the second content and sends it to the control device 101. The listed second content is sent from the control device 101 to the communication device 104. The communication device 104 delivers the second content to the display apparatus 2 through the network (step S106).

Here, the obtainment of the second content on the information obtaining device 102 and the listing of the second content on the delivery control device 103 may be performed, as occasion demands, regardless of the timing that the control device 101 receives the delivery request. According to this operation, it is possible to omit a process in obtaining the second content, from a series of delivery process, and it is possible to reduce the processes or operations performed between the reception of the delivery request and the delivery of the second content.

On the display apparatus 2, the delivered second content is sent from the communication device 204 to the control device 201 and displayed on the display device 203 (step S107). At this time, the first content is displayed on the display device 203, and the second content may be displayed so as to be superimposed on the first content. In that case, the second content may be displayed, not by occupying all of the display device 203 but by using a part of the display device 208. According to this operation, it is possible to display the second content without preventing the user's first content watching.

Incidentally, the display of the second content may be automatically ended in accordance with the user's additional operation or after a lapse of a predetermined time from the start of the display. According to this operation, it has an effect to prevent that the second content that the user finished watching keeps displayed on the display device 203 and obstructs the first content watching.

After the second content is displayed on the display device 203, the user's first content watching is continued, and the information delivery system waits for the user's next operation.

On the other hand, if the detected user's operation is not changing the first content (the step S104: No), then, it is judged on the operation analysis device 206 whether or not the operation is an operation of ending the first content watching (step S108). Specifically, an operation of switching off the display apparatus 2 or the like corresponds to this operation of ending the watching.

If the operation is the operation of ending the first content watching (the step S108: Yes), the information delivery system stops the subsequent processes and ends the operations of the system.

If the operation is not the operation of ending the first content watching (the step S108: No), the user's first content watching is continued, and the information delivery system waits for the user's next operation.

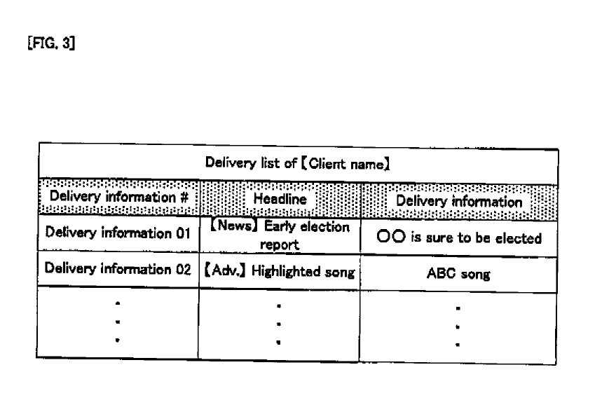

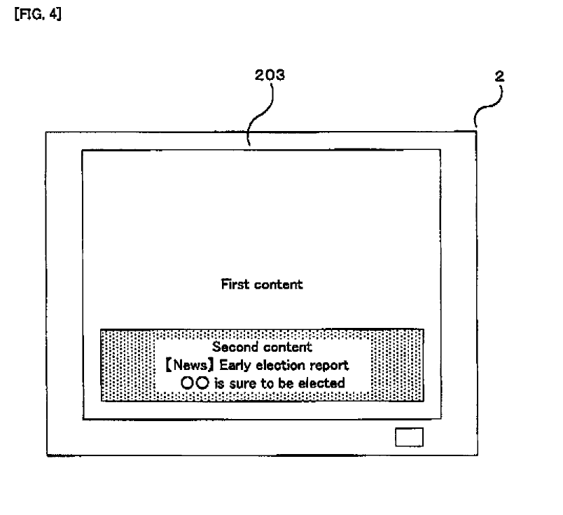

Next, the delivery and display of the second content will be explained with reference to FIG. 3 and FIG. 4. FIG. 3 shows one example of the second content listed by the delivery control device 103. Each of the second contents to be delivered has an identification number assigned and has a headline for classification and a second content main body to be delivered. The listed second content is transmitted to the display apparatus 2 in response to the delivery request and is displayed.

Here, as for the listing of the second content, the content to be listed may be selected in response to the user's preference. According to this operation, it is possible to bring the delivered second content close to the user's desire and to deliver the content that meets more of the user's needs.

FIG. 4 is a screen image when the second content is displayed so as to be superimposed on the first content displayed on the display device 203. In this image, the second content is displayed by completely covering and not occupying all of the first content and by using a part of the first content. In this aspect, it is possible to display the second content without completely preventing the user's first content watching.

Here, if the first content is the content to be watched, such as terrestrial, CS, ES broadcast content or the like, data delivered through the network, and output from a recording/reproducing apparatus connected to the display apparatus 2, the first content is not limited to the aforementioned exemplification and can be changed, as occasion demands, and is inputted to the display apparatus 2 by the first content input device 202.

As a result, according to the first example, it is possible to display the desired second content in proper timing which class not prevent the user's first content watching (i.e. in timing to change the first content).

### First Modified Example

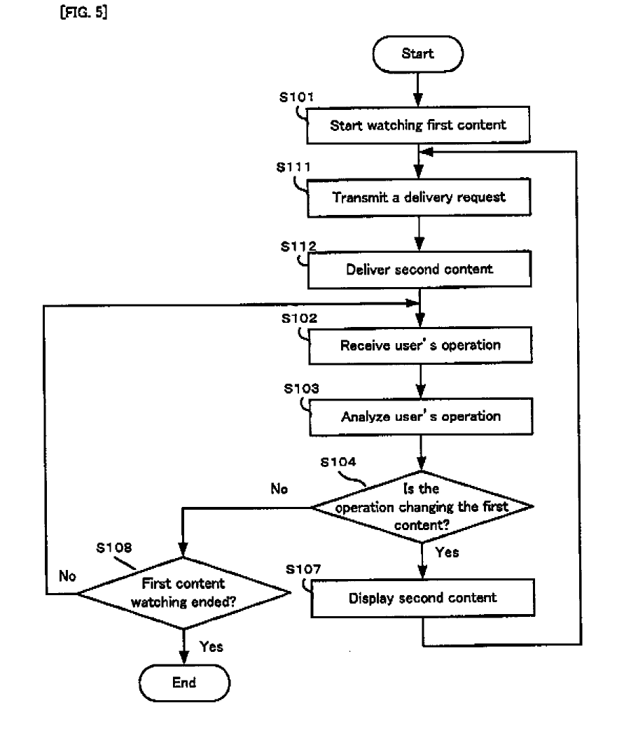

The structure of an information delivery system in a first modified example will be explained with reference to FIG. 5. FIG. 5 is a flowchart showing the operations of the information delivery system in the first modified example.

In the aforementioned first example, the delivery of the second content is requested when the user's operation to the display apparatus 2 is received by the operation reception device 206 and the operation is analyzed to be the operation of changing the first content. On the other hand, the same effect can be also obtained even in such construction that receives the delivery of the second content in advance (step S111 and step S112), and displays the second content that is already received, when the user's operation is analyzed to be the operation of changing the first content.

Moreover, according to this operation, it is possible to omit the process of transmitting the delivery request and the process of receiving the delivery of the second content after the user's operation is analyzed, and it is possible to reduce the processes or operations performed between the detection of the operation of changing the first content and the delivery of the second content.

The process of sending the delivery request to the information delivery apparatus 1 (the step S105) and the process of delivering the second content to the display apparatus 2 (the step S106) in FIG. 2 in the first example are performed before the process of receiving the user's operation (the step S102) in this modified example. After the second content is displayed (the step S107), the delivery of the second content is requested again (the step S111). The other processes are the same as in the first example.

As a result, according to the first modified example, as in the first example, it is possible to display the desired second content in proper timing which does not prevent the user's first content watching.

### Second Modified Example

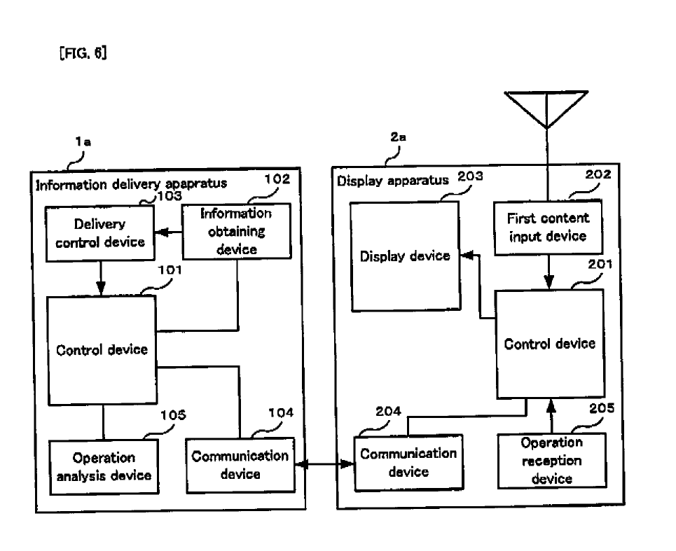

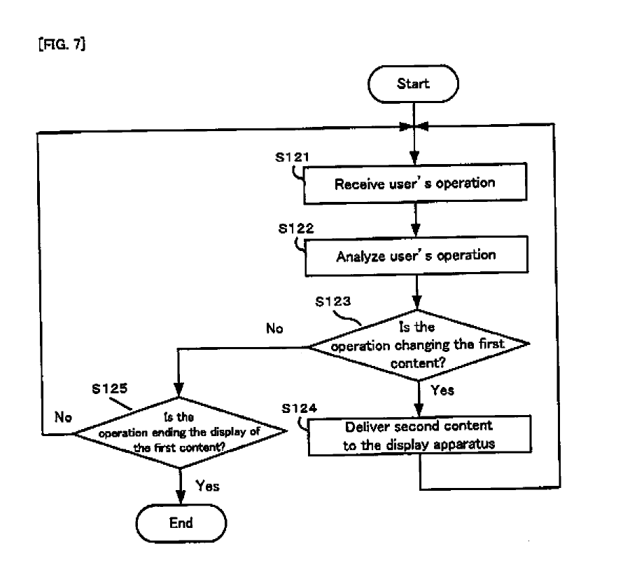

The structure of an information delivery system in a second modified example will be explained with reference to FIG. 6 and FIG. 7. FIG. 6 is a block diagram showing the structure of the information delivery system in the second modified example of the present invention.

In the aforementioned first example, the display apparatus 2 is provided with the operation analysis 206 for analyzing the user's operation. On the other hand, a display apparatus 2a in the second modified example may transmit the detected user's operation to the information delivery apparatus 1 through the network. An information delivery apparatus 1a provided with an operation analysis device 105 may analyze the user's operation and deliver the second content in response to the analysis result.

In FIG. 6, the operation reception device 205 receives the user's operation and sends it to the control device 201. The control device 201 transmits the user's operation to the information delivery apparatus 1a through the communication device 204. On the information delivery apparatus 1a, the user's operation is sent by the control device 101 to the operation analysis device 105 and is analyzed. If the operation is judged to be the operation of changing the first content, the control device 101 is notified of the judgment and allows the second content to be delivered.

The details of the operations of the information delivery apparatus 1a having the operation analysis device 105 will be explained with reference to a flowchart in FIG. 7.

Firstly, in response to the reception of the user's operations from the display apparatus 2a (step S121), the user's operation is analyzed on the operation analysis device 105 (step S122). If the user's operation is the operation of changing the first content (step S123: Yes), the control device 101 is notified of the judgment and allows the second content to be delivered to the display apparatus 2a by the delivery control device 103 (step S124). After the delivery, the information delivery system waits for the user's operation from the display apparatus 2a again.

If the user's operation is not the operation of changing the first content (the step S128: No), then, it is judged whether or not the operation is the operation of ending the first content watching (step S125). If the operation is the operation of ending the first content watching (the step S125: Yes), the information delivery apparatus 1a stops the subsequent processes and ends the operations of the system.

If the operation is not the operation of ending the first content watching (the step S125: No), the information delivery system waits for the transmission of the user's operation from the display apparatus 2a again.

As a result, according to the second modified example, as in the first example, it is possible to display the desired second content in proper timing which does not prevent the user's first content watching.

Moreover, according to the second modified example, it is possible to deliver the second content in proper timing which does not prevent the user's first content watching without the operation analysis operation 105 within the display apparatus 2a. Moreover, one information delivery apparatus 1a may allow a plurality of display apparatuses 2a owned by individual users to perform the processes. At that time, a working process, such as the analysis of the operation and the judgment of the operation of changing the first content, is easily managed, and when the working process is revised, it is possible to relatively easily respond to the revision.

### Third Modified Example

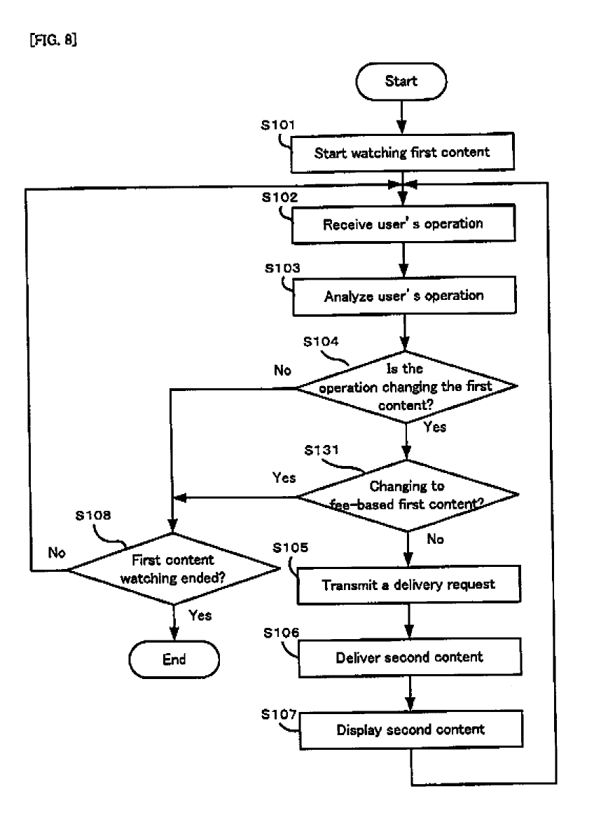

The structure of an information delivery system in a third modified example will be explained with reference to FIG. 8. FIG. 8 is a flowchart showing the operations of the information delivery system in the third modified example of the present invention.

As an example corresponding to all the aforementioned examples, in this modified example, the second content is not delivered when the user watches fee-based first content in the operation of changing the first content. The fee-based first content herein indicates the first content which is charged for watching.

According to this aspect, because the user is highly interested in the first content that the user pays and watches and the display of the second content supposedly prevents the user's watching, the second content is not displayed while the user watches the fee-based content.

In the flowchart in this modified example shown in FIG. 8, after the user's operation is judged to be the operation of changing the first content (the step S104: Yes) in FIG. 2 in the first example, a process of judging whether or not the operation of changing the first content is changing to the fee-based first content (step S131) is added. If the operation of changing the first content is changing to the fee-based first content (the step S131: Yes), the delivery is not requested. The delivery is requested only if the operation is not changing to the fee-based first content (the step S131: No) (the step S105). The other processes are the same as in the first example.

As a result, according to the third modified example, as in the first example, it is possible to display the desired second content in proper timing which does not prevent the user's first content watching.

### Fourth Modified Example

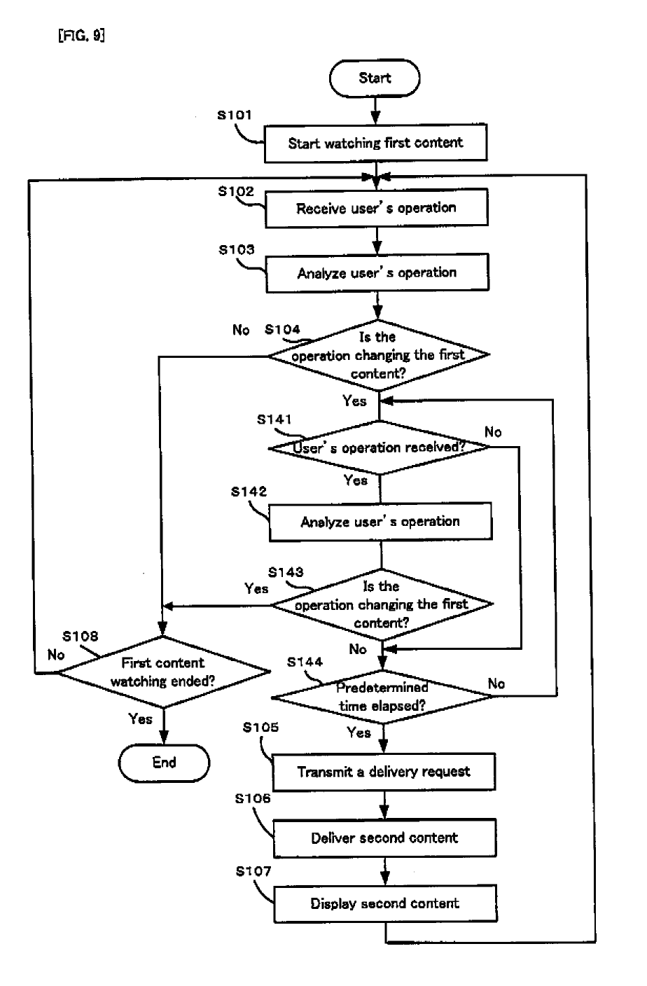

The structure of an information delivery system in a fourth modified example will be explained with reference to FIG. 9. FIG. 9 is a flowchart showing the details of the operations of the information delivery system in the fourth modified example of the present invention.

As an example corresponding to all the aforementioned examples, in this modified example, the second content is not delivered if the user continuously changes the first content in a short time.

According to this aspect, there is a predetermined time interval from the detection of changing the first content to the display of the second content.

The user's continuously changing the first content in a short time is supposedly the user's concentrating on searching for the first content to watch, so that the display of the second content likely prevents the changing operation. On the other hand, if the user performs the operation of changing the first content and performs the next operation of changing the first content a certain degree of time interval, the user supposedly searches for the first content to watch while confirming the content of the first content, so that the user highly likely takes an interest by displaying the second content related to the first content at that time.

In the flowchart in this modified example shown in FIG. 9, after the user's operation is judged to be the operation of changing the first content (the step S104: Yes) in FIG. 2 in the first example, it is judged whether or not the user's next operation is further received (step S141).

At this time, if the user's next operation is further received (the step S141: Yes), the user's next operation is analyzed (step S142). If the user's next operation is the operation of changing the first content (step S143: Yes), the delivery is not requested.

On the other hand, if the user's next operation is not received (the step S141: No) or if the user's next operation is not the operation of changing the first content (step S143: No), it is judged whether or not a predetermined time has elapsed since the first operation of changing the first content (step S144). If not (the step S144: No), the information delivery system waits for the user's next operation. If the predetermined time has elapsed (the step S144: Yes), the delivery of the second content is requested (the step S105). The other processes are the same as in the first example.

As a result, according to the fourth modified example, as in the first example, it is possible to display the desired second content in proper timing which does not prevent the user's first content watching.

### Second Example

A second example of the information delivery system of the present invention will be explained with reference to the drawings. Incidentally, the same constituent elements in the drawings will carry the same referential numerals.

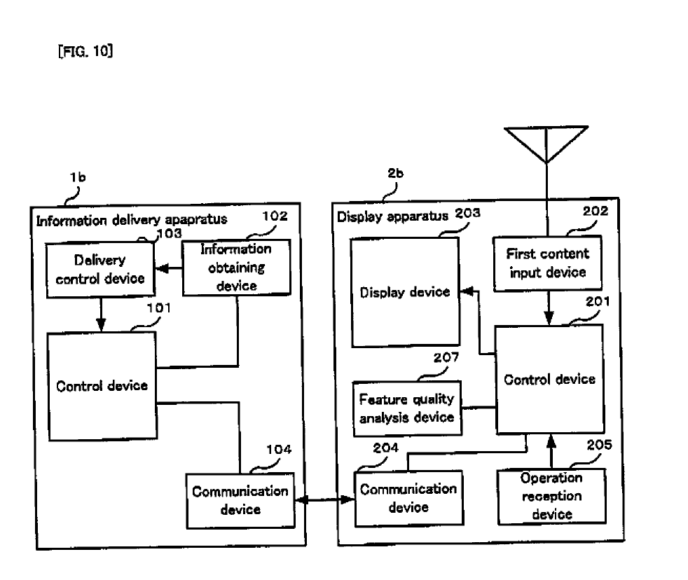

Firstly, the structure of the information delivery system in the second example will be explained with reference to FIG. 10.

In the aforementioned first example, the display apparatus 2 is provided with the operation analysis device 206 for analyzing the user's operation. Instead, a display apparatus 2b in the second example shown in FIG. 10 is provided with a feature quantity analysis device 207 for analyzing the feature quantity of the first content displayed on the display apparatus 2b. The other structure is the same as that of the first example in FIG. 1; however, each of an information delivery apparatus 1b and the display apparatus 2b has a changed referential numerical in this example shown in FIG. 10.

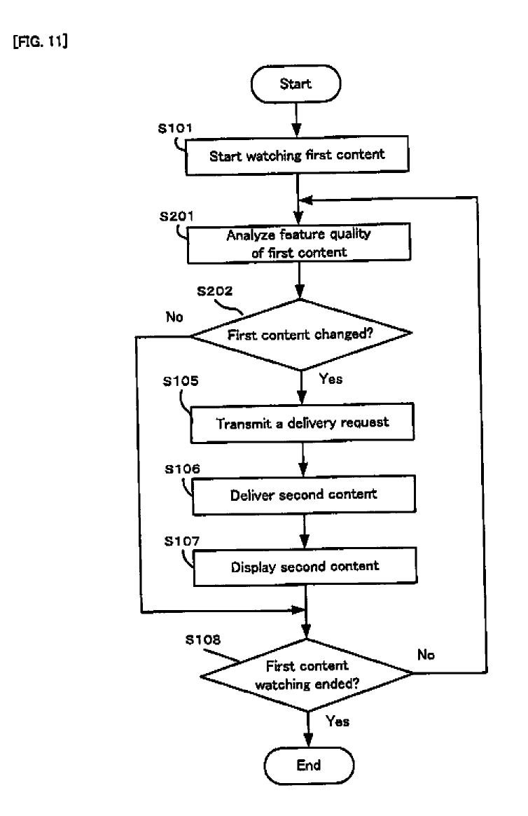

Next, the details of the operations of the information delivery system as constructed above will be explained with reference to a flowchart in FIG. 11.

In the operations in the second example shown in FIG. 11, the following steps in the first example shown in FIG. 2 are replaced: the process in the step S102 that the operation reception device 205 detects the user's operation and transmits the operation content to the control device 201, the process in the step S103 that the control device 201 passes the user's operation to the operation analysis device 206 and the user's operation is analyzed on the operation analysis device 206, and the process in the step S104 that it is judged whether or not the user's operation is changing the first content.

That is, the feature quantity of the first content that the control device 201 currently allows the display device 203 to display in response to the input on the first content input device 202 is analyzed on the feature quantity analysis device 207 (step S201). The analysis is desirably performed simultaneously with the display of the first content.

Then, in the analysis of the feature quantity of the displayed first content, the feature quantity analysis device 207 judges whether or not there is a change in the feature quantity (step S202). In the analysis of the change in the feature quantity, if a predetermined change determined in advance is detected, it is considered that the change in the feature quantity is a change in the first content (the step S202: Yes), and the process of transmitting the request for the delivery of the second content in the step S105 is performed. If the change in the feature quantity is not the predetermined change (the step S202: No), the operational flow moves to the judgment of whether or not the first content watching is ended in the step S108.

Incidentally, the “change in the first content” means that the predetermined change is made in the displayed content, such as a change in the content of the displayed content (e.g. a change in segments, like a change from sports news to weather forecast in a news program) and a change between a program and CM (Commercial Message). Incidentally, the “feature quantity” referred to in order to detect the change in the first content is not particularly limited if it can specify the features of the first content (e.g. a feature as video, a feature as audio, or the like). As for a method of detecting the change in the first content on the basis of the feature quantity, refer to Japanese Patent Application Laid Open No. 2002-047377 and Japanese Patent Application Laid Open No. 2002-230598.

On the information delivery apparatus 1 which has received the delivery request, the delivery request is sent from the communication device 104 to the control device 101. The second content obtained on the information obtaining device 102 is sent to the delivery control device 103. The delivery control device 103 lists the second content and sends it to the control device 101. The listed second content is sent from the control device 101 to the communication device 104, and the communication device delivers the second content to the display apparatus 2 through the network (the step S106). The other processes are the same as in the first example.

The delivery and display of the second content are performed as shown in FIG. 3 and FIG. 4, as in the first example.

As a result, according to the second example, the second content is displayed in timing to change the displayed first content to different first content. The predetermined change in the displayed content means that the watching of the first content which has been watched is ended or interrupted, and the user's interest in the first content after the change is supposedly lower than before the change. By displaying news, advertisement, or the like as the second content in this timing, it is possible to display the second content without preventing the user's first content watching. In other words, it is possible to display the desired second content in proper timing which does not prevent the user's first content watching (i.e. in timing to change the first content).

Incidentally, in the aforementioned explanation, the “change in the first content” is detected by monitoring the feature quality of the first content. However, if the first content itself includes information indicating the “change in the first content” (e.g. information for identifying CM or the like), the “change in the first content” may be detected with reference to the information.

### Fifth Modified Example

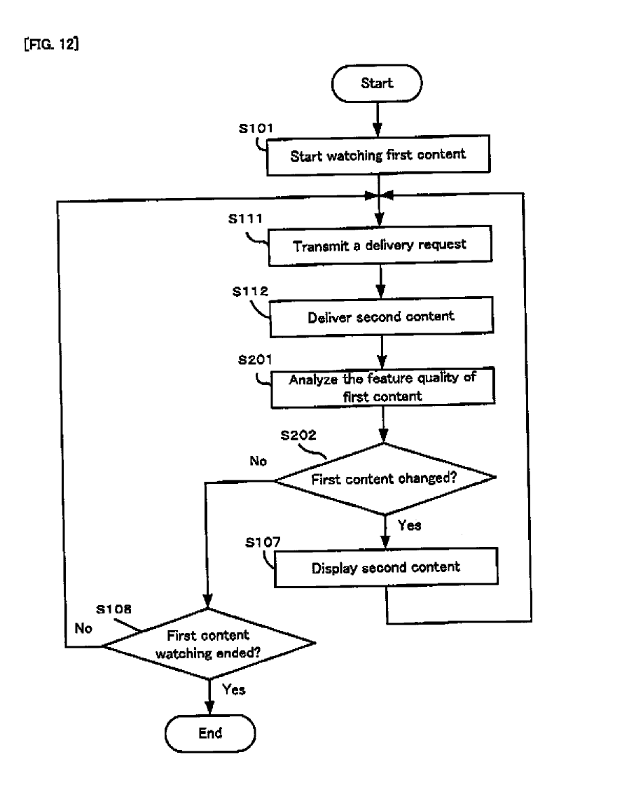

The structure of an information delivery system in a fifth modified example will be explained with reference to FIG. 12, FIG. 12 is a flowchart showing the operations of the information delivery system in the fifth modified example of the present invention.

In the aforementioned second example, if the feature quality of the first content displayed on the display apparatus 2b is analyzed by the feature quality analysis device 207 and the predetermined change determined in advance in the feature quantity is detected, the control device 201 requests the delivery of the second content. The same effect can be obtained even in such construction that the second content delivered in advance is displayed when the control device 201 firstly receives the delivery of the second content (the step S111 and the step S112) and detects the predetermined change determined in advance in the feature quantity of the first content.

Moreover, according to this operation, it is possible to omit the process of transmitting the delivery request and the process of receiving the delivery of the second content after the predetermined change is detected in the feature quantity, and it is possible to reduce the processes or operations performed between the detection of the predetermined change in the feature quantity and the delivery of the second content.

The process of sending the delivery request to the information delivery apparatus 1 (the step S105) and the process of delivering the second content to the display apparatus 2 (the step S106) in FIG. 11 in the second example are performed before the process of analyzing the feature quantity of the first content (the step S201) in this modified example. After the display of the second content (the step S107), the delivery of the second content is requested again (the step S111). The other processes are the same as in the second example.

As a result, according to the fifth modified example, as in the second example, it is possible to display the desired second content in proper timing which does not prevent the user's first content watching.

### Sixth Modified Example

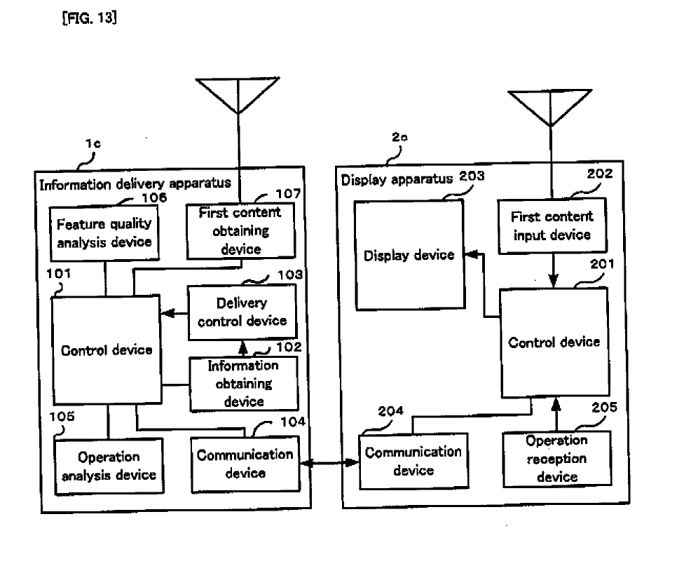

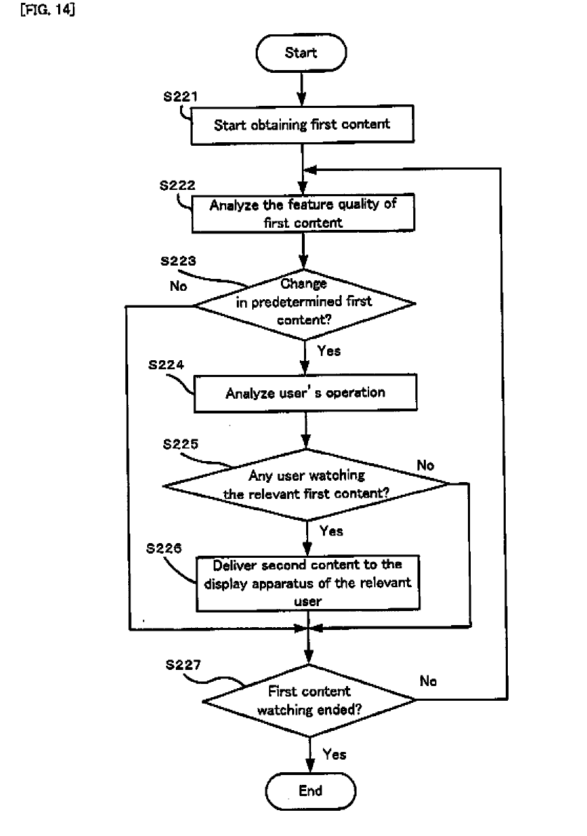

The structure of an information delivery system in a sixth modified example will be explained with reference to FIG. 13 and FIG. 14. FIG. 13 is a block diagram showing the information delivery system in the sixth modified example of the present invention.

The display apparatus 2b is provided with the feature quality analysis device 207 for analyzing the feature quality of the first content displayed on the display apparatus 2b in the aforementioned second example. However, a display apparatus 2c in the sixth modified example is not provided with the feature quality analysis device 207, but an information delivery apparatus is in the sixth modified example may be provided with a device for analyzing the feature quality of the first content displayed on the display apparatus 2c and may deliver the second content in response to the result.

The information delivery apparatus 1c in the sixth modified example is provided with a first content obtaining device 107 for obtaining the first content which is possibly displayed by the display apparatus 2c; a feature quality analysis device 106 for analyzing the feature quality of the first content obtained by the first content obtaining device 107; and an operation analysis device 105 for analyzing the user's operation transmitted from the display apparatus 2c and for specifying the first content currently displayed on the display apparatus 2c.

The details of the operations of the information delivery apparatus 1c will be explained with reference to a flowchart in FIG. 14.

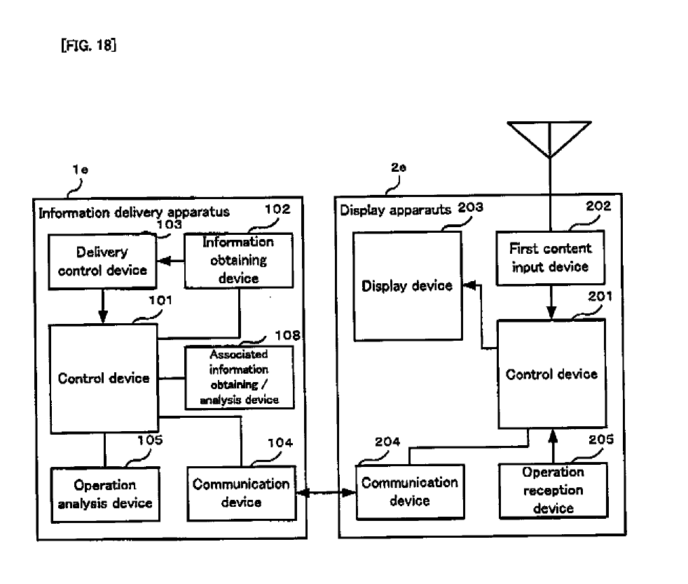

In FIG. 18, the first content obtaining device 107 obtains the first content which is possibly displayed by the display apparatus 2c (step S221). Then, the feature quality analysis device 106 analyzes the feature quality of each of the obtained first contents (step S222).

In the analysis of the feature quality of the obtained first content, the feature quality analysis device 106 judges whether or not there is a change in the feature quality (step S223). In the analysis of the change in the feature quality, if a predetermined change in the feature quality determined in advance is detected in at least one of the obtained first content, it is judged that the change in the feature quality is a change in the first content (the step S223: Yes).

Then, the operation analysis device 106 analyzes the transmitted user's operation in the same procedure as in the second modified example and specifies the first content currently displayed on the display apparatus 2c (step S224). Then, if there is the display apparatus 2c which displays the first content with its change detected (step S225: Yes), the control device 101 allows the second content to be delivered to the display apparatus 2c which displays the first content with the change detected by the deliver control device 103 (step S226). After the delivery, as long as the display apparatus 2c does not end the display of the first content, the feature quality of the obtained first content is analyzed again (the step S222).

On the other hand, if the change is not detected in the obtained first content (the step S228: No) or if there is no display apparatus 2c which displays the first content with the change detected (the step S226: No), the feature quality of the obtained first content is analyzed again in the same manner (the step S222).

As a result, according to the sixth modified example, as in the second example, it is possible to display the desired second content in proper timing which does not prevent the user's first content watching.

Moreover, according to the sixth modified example, it is possible to display the desired second content in proper timing which does not prevent the user's first content watching without the feature quality analysis device 206 within the display apparatus 2c. Moreover, one information delivery apparatus 1c may allow a plurality of display apparatuses 2c owned by individual users to perform the processes. At that time, a working process, such as the analysis of the feature quality and the detection of the predetermined change determined in advance, is easily managed, and when the working process is revised, it is possible to relatively easily respond to the revision.

### Third Example

A third example of the information delivery system of the present invention will be explained with reference to the drawings. Incidentally, the same constituent elements in the drawings will carry the same referential numerals.

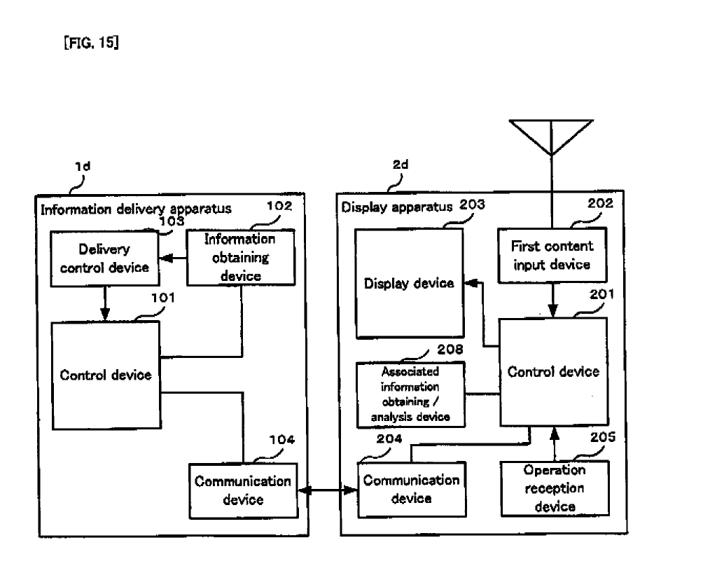

Firstly, the structure of the information delivery system in the example will be explained with reference to FIG. 15.

In the aforementioned first example, the display apparatus 2 is provided with the operation analysis device 206 for analyzing the user's operation. Instead, a display apparatus 2d in the third example shown in FIG. 15 is provided with an associated information obtaining/analysis device 208 for obtaining associated information including the end time point of the first content displayed on the display apparatus 2d (e.g. EPG information or the like) and for extracting the end time point of the first content. The other structure is the same as in the structure in the first example in FIG. 1; however, each of an information delivery apparatus 1d and the display apparatus 2d has a changed referential numerical in this example shown in FIG. 15.

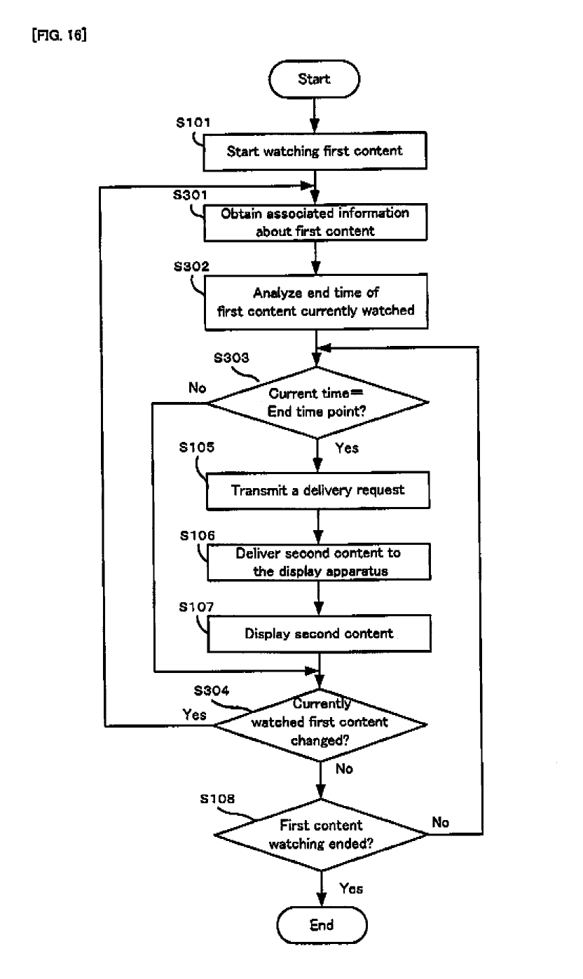

Next, the details of the operations of the information delivery system as constructed above will be explained with reference to a flowchart in FIG. 16.

In the operations in the third example shown in FIG. 16, the following steps are replaced in the first example shown in FIG. 2: the process in the step S102 that the operation reception device 205 detects the user's operation and transmits the operation content to the control device 201, the process in the step S103 that the control device 201 passes the user's operation to the operation analysis device 206 and that the user's operation is analyzed on the operation analysis device 206, the process in the step S104 that it is judged whether or not the user's operation is changing the first content.

That is, the associated information obtaining/analysis device 208 is notified by the control device 201 of the first content that the control device 201 currently allows the display device 203 to display in response to the input on the first content input device 202, and the associated information about the first content is obtained by the associated information obtaining/analysis device 208 (step S301). The associated information obtaining/analysis device 208 extracts the end time point of the first content from the obtained associated information about the first content (step S302).

Then, the associated information obtaining/analysis device 208 judges whether or not the current time point is the extracted end time point of the first content (step S303).

If the current time point is the extracted end time point of the first content (the step S303: Yes), the associated information obtaining/analysis device 208 notifies the control device 201, and the control device 201 performs the process of transmitting the request for the request of the second content in the step S105.

If the current time point is not the extracted end time point of the first content (the step S303: No) or if the display of the second content is ended in the step S107, then, it is judged whether or not the first content displayed on the display apparatus 2d is changed (step S304).

Here, the change in the first content displayed on the display apparatus 2d indicates that the displayed first content is changed to another first content by the user's operation or a change in the input of the content, and it is detected by the operation reception device 205 or the first content input device 202, and the control device 201 is notified of the change.

If it is notified of the change in the first content (the step S304: Yes), the control device 201 notifies the associated information obtaining/analysis device 208, and the associated information obtaining/analysis device 208 moves to the process of obtaining the associated information with respect to the first content after the change (the step S301).

Here, in the step S301, the associated information about all the first content that is possibly watched by the user may be obtained in advance, and it is possible to omit the step S301 after the step S304 in this aspect.

On the other hand, if there is no change in the first content (the step S304: No), the operational flow moves to the judgment of whether or not the first content watching is ended in the step S108.

The other processes are the same as in the first example.

The delivery and display of the second content are performed as shown in FIG. 3 and FIG. 4 as in the first example.

As a result, according to the third example, the second content is displayed in the timing that the current time point is the end time point of the displayed first content and at the end of the displayed first content. At the end of the displayed first content, the watching of the first content which has been watched is ended, and the user's interest in the first content is supposedly lower than when the first content is watched. By displaying news, advertisement, or the like as the second content in this timing, it is possible to display the second content without preventing the user's first content watching. In other words, it is possible to display the desired second content in proper timing which does not prevent the user's first content watching (i.e. in timing to change the first content).

Incidentally, in the aforementioned explanation, the end time point of the first content means a time point at which the individual content is ended, such as the program end time point of displayed broadcast content and the end time point of displayed video content. Moreover, the first content herein may be a program which is a group of contents coherent each other or individual content itself.

### Seventh Modified Example

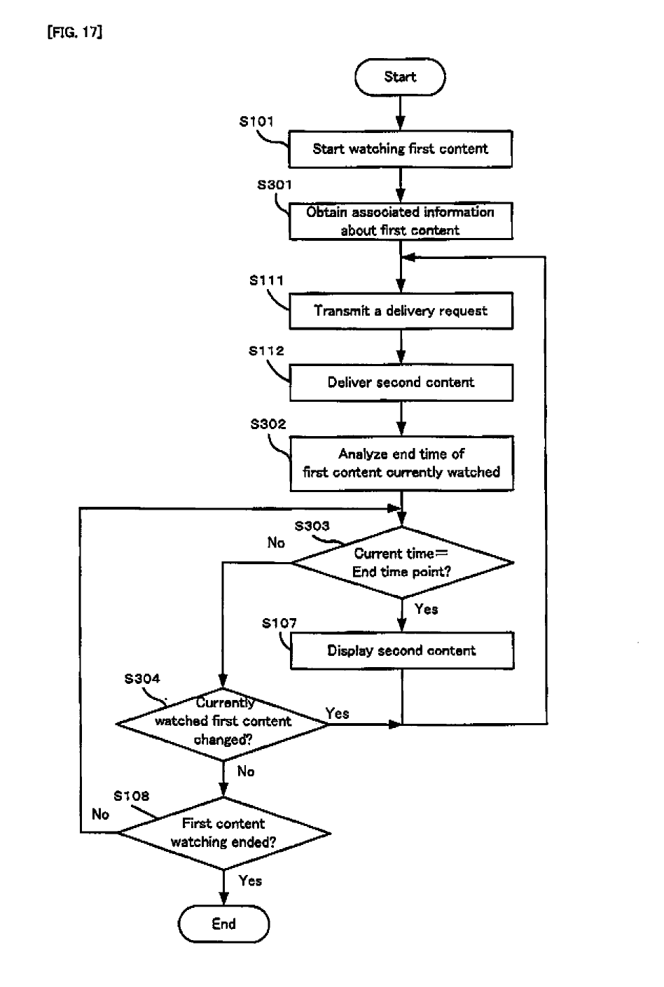

The structure of an information delivery system in a seventh modified example will be explained with reference to FIG. 17. FIG. 17 is a flowchart showing the operations of the information delivery system in the seventh modified example of the present invention.

In the aforementioned third example, the control device 201 requests the delivery of the second content if the associated information obtaining/analysis device 208 obtains the associated information including the end time point of the first content displayed on the display apparatus 2d (the step S301), if the associated information obtaining/analysis device 208 extracts the end time point of the first content (the step S302), and if the current time point of the first content is judged to be the end time point of the first content (the step S303). On the other hand, the same effect is obtained even in such construction that the delivery of the second content is received in advance (the step S111 and the step S112) and that the second content delivered in advance is displayed if the associated information obtaining/analysis device 208 obtains the associated information and extracts the end time point of the first content and the current time point of the first content is the end time point of the first content.

Moreover, according to this operation, it is possible to omit the process of transmitting the delivery request and the process of receiving the delivery of the second content if the current time point of the first content is the end time point of the first content. It is possible to reduce the number of processes from the judgment that the current time point of the first content is the end time point of the first content to the delivery of the second content.

The other processes are the same as in the third example.

As a result, according to the seventh modified example, as in the third example, it is possible to display the desired second content in proper timing which does not prevent the user's first content watching.

### Eighth Modified Example

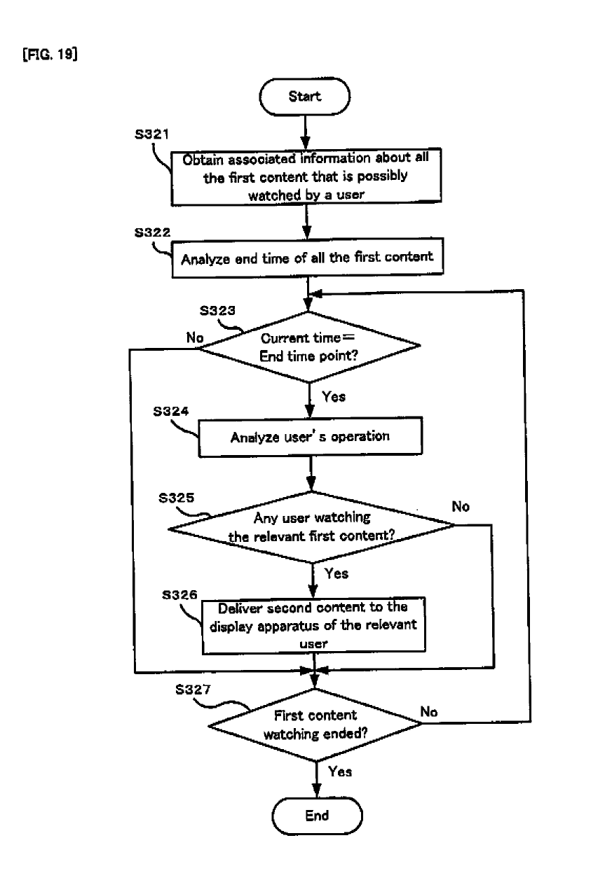

The structure of an information delivery system in an eighth modified example will be explained with reference to FIG. 18 and FIG. 19. FIG. 18 is a block diagram showing the information delivery system in the eighth modified example of the present invention.

In the aforementioned third example, the display apparatus 2d is provided with the associated information obtaining/analysis device 208 for obtaining the associated information including the end time point of the first content displayed on the display apparatus 2d and for extracting the end time point of the first content. A display apparatus 2e in the eighth modified example is not provided with the associated information obtaining/analysis device 208, but an information delivery apparatus 1e in the eighth modified example may be provided with an associated information obtaining/analysis device 108 for obtaining the associated information including the end time point of the first content displayed on the display apparatus 2e and for extracting the end time point of the first content, and the information delivery apparatus 1e provided with the associated information obtaining/analysis device 108 may analyze the end time point and may deliver the second content in response to the result.

The information delivery apparatus 1e in the eighth modified example is provided with the associated information obtaining/analysis device 108 for obtaining the associated information including the end time point of the first content which is possibly displayed by the display apparatus 2e and for extracting the end time point of the first content; and the operation analysis device 105 for analyzing the user's operation transmitted from the display apparatus 2e and for specifying the first content currently displayed on the display apparatus 2e.

The details of the operations of the information delivery apparatus 1e will be explained with reference to a flowchart in FIG. 19.

In FIG. 19, the associated information obtaining/analysis device 108 obtains the associated information including the end time point of the first content which is possibly displayed by the display apparatus 2e (step S321). Then, in each of the obtained first contents, the associated information obtaining/analysis device 108 extracts the end time point of the first content (step S322).

The associated information obtaining/analysis device 108 judges whether or not the current time point is the end time point of the first content in each of the obtained first contents (step S323). If the current time point is the end time point of the first content in at least one of the obtained first content (the step S323: Yes), then, the operation analysis device 105 analyzes the user's operation transmitted in the same procedure as in the second modified example and specifies the first content currently displayed on the display apparatus 2e (step S824).

Then, if there is the display apparatus 2e on which the current time point is judged to be the end time point of the first content in the specific first content (the step S325: Yes), the control device 101 delivers the second content to the display apparatus 2e which displays the first content with the change detected by the delivery control device 103 (step S326). After the delivery, as long as the display apparatus 2e does not end the display of the first content, it is judged again whether or not the current time point is the end time point of the first content (the step S322).

On the other hand, if there is no first content in which the current time point is the end time point of the first content (the step S323: No) or if there is no display apparatus 2e on which the current time point is judged to be the end time point of the first content in the specific first content (the step S325: No), it is judged again whether or not the current tune point is the end time point of the first content in the same manner (the step S322).

As a result, according to the eighth modified example, as in the third example, it is possible to display the desired second content in proper timing which does not prevent the user's first content watching.

Moreover, according to the eighth modified example, it is possible to deliver the second content in proper timing which does not prevent the user's first content watching without the associated information obtaining/analysis device 208 within the display apparatus 2e. Moreover, one information delivery apparatus 1e may allow a plurality of display apparatuses 2e owned by individual users to perform the processes. At that time, the process of obtaining the associated information about the first content, the process of extracting the end time point of the first content from the obtained associated information, or the working process when it is judged whether or not the current time point is the extracted end time point of the first content is easily managed, and when the working process is revised, it is possible to relatively easily respond to the revision.

Incidentally, the present invention is not limited to the aforementioned examples, but various changes may be made, if desired, without departing from the essence or spirit of the invention which can be read from the claims and the entire specification. An information delivery system and method, a content delivery apparatus, and a display apparatus, all of which involve such changes, are also intended to be within the technical scope of the present invention.

1-12. (canceled)

13. An information delivery system comprising: a display apparatus comprising a displaying device for displaying first content; and an information delivery apparatus comprising a delivering device for delivering second content to said display apparatus through a predetermined network,
said display apparatus comprising:
a judging device for judging whether or not the first content displayed by the displaying device is changed to content different from the first content;
a controlling device for controlling the displaying device to display the second content delivered from said information delivery apparatus if it is judged that the first content displayed by the displaying device is changed to the content different from the first content; and
a requesting device for requesting said information delivery apparatus to deliver the second content if it is judged that the first content displayed by the displaying device is changed to the content different from the first content,
the delivering device delivering the second content after the request by the requesting device.

14. The information delivery system according to claim 13, wherein
at least one of said display apparatus and said information delivery apparatus further comprises an extracting device for extracting feature quantity information indicating features of the first content displayed by the displaying device,
the judging device judges whether or not there is a poor correlation in the first content between before and after the change when the first content displayed by the displaying device is changed to the content different from the first content, on the basis of the feature quality information, and
the controlling device controls the displaying device to display the second content delivered from said information delivery apparatus if it is judged that there is the poor correlation in the first content between before and after the change when the first content displayed by the displaying device is changed to the content different from the first content.

15. The information delivery system according to claim 13, wherein the first content is a broadcast program broadcasted in accordance with a program determined in advance, and the first content is different from the second content delivered through the network from said information delivery apparatus.

16. The information delivery system according to claim 13, wherein
the delivery device delivers the second content in advance, and
the controlling device controls the displaying device to display the second content delivered in advance if it is judged that the displayed first content is changed to the content different from the first content.

17. An information delivery system comprising: a display apparatus comprising a displaying device for displaying first content; and an information delivery apparatus comprising a delivering device for delivering second content to said display apparatus through a predetermined network,
said information delivery apparatus comprising a judging device for judging whether or not the first content displayed by the displaying device is changed to content different from the first content,
said display apparatus comprising a controlling device for controlling the displaying device to display the second content delivered from said information delivery apparatus if it is judged that the first content displayed by the displaying device is changed to the content different from the first content,
the delivering device delivering the second content if it is judged that the first content displayed by the displaying device is changed to the content different from the first content.

18. The information delivery system according to claim 17, wherein
said information delivery apparatus further comprises an information obtaining device for obtaining the same first content as the first content displayed on said display apparatus, and
the delivering device delivers the second content if it is judged that the first content obtained by the information obtaining device is changed to the content different from the first content.

19. The information delivery system according to claim 13, wherein the controlling device controls the displaying device to display the second content on top of the first content.

20. The information delivery system according to claim 13, wherein said information delivery apparatus further comprises:
an obtaining device for obtaining the second content from external recording equipment or the network; and
a delivery controlling device for storing the obtained second content and listing the second content to be delivered to said display apparatus.

21. An information delivery apparatus comprising:
a delivering device for delivering second content to a display apparatus comprising a displaying device for displaying first content, through a network;
a judging device for judging whether or not the first content displayed on said display apparatus is changed to content different from the first content; and
a transmitting device for transmitting display start information for starting the display of the second content on said display apparatus, to said display apparatus, to said display apparatus if it is judged that the first content displayed by the displaying device is changed to the content different from the first content.

22. An information delivery method comprising:
a delivering process of delivering second content through a network to a display apparatus comprising a displaying device for displaying first content;
a judging process of judging whether or not the first content displayed on said display apparatus is changed to content different from the first content; and
a transmitting process of transmitting display start information for starting the display of the second content on said display apparatus to said display apparatus if it is judged that the first content displayed in said display process is changed to the content different from the first content.

23. The information delivery system according to claim 14, wherein the first content is a broadcast program broadcasted in accordance with a program determined in advance, and the first content is different from the second content delivered through the network from said information delivery apparatus.

24. The information delivery system according to claim 14, wherein
the delivery device delivers the second content in advance, and
the controlling device controls the displaying device to display the second content delivered in advance if it is judged that the displayed first content is changed to the content different from the first content.

25. The information delivery system according to claim 14, wherein the controlling device controls the displaying device to display the second content on top of the first content.

26. The information delivery system according to claim 14, wherein said information delivery apparatus further comprises:
an obtaining device for obtaining the second content from external recording equipment or the network; and
a delivery controlling device for storing the obtained second content and listing the second content to be delivered to said display apparatus.
